(19) United States
(12) Patent Application Publication
(10) Pub. No.: US 2005/0251528 A1
(43) Pub. Date: Nov. 10, 2005

(54) System to check and certify the authenticity of labels

(76) Inventors: Claudio Selva, Biella-IT (IT); Maurizio Platone, Cervinia Valtournenche (AO) (IT); Vincenzo Serrani, Candelo (BI) (IT)

Correspondence Address: YOUNG & THOMPSON, 745 SOUTH 23RD STREET, 2ND FLOOR, ARLINGTON, VA, 22202, US

(21) Appl. No.: 11/059,302

(22) Filed: Feb. 17, 2005

Related U.S. Application Data
(63) Continuation of application No. 10/495,625.

(30) Foreign Application Priority Data
Nov. 14, 2001 (EP) 01830703.3

(51) Int. Cl. B42D 15/00

(52) U.S. Cl. 707/102

(57) ABSTRACT

A system to check and certify the authenticity of labels provided with a marking consisting of one or more identification signs, includes: a) an alphanumeric code identifying each label; b) a set of memorizable and comparable data drawn from the label, which evidences a distinctive feature thereof; c) an information schedule concerning the articles or objects marked by the labels; d) a multiple-access data base into which are memorized, for each label, the alphanumeric code, the set of data, and the information schedule; e) a data transmission network allowing interested subjects, and an independent certifying agency, to gain access to said data base. The access to the data base allows a first monitoring level (check), which requires sending to the data base the alphanumeric code of the label, and a second monitoring level (certification), which requires sending to the data base the set of data drawn from the label.

This application is a continuation of co-pending application Ser. No. 10/495,625, filed May 14, 2004, which is the national phase of PCT International Application No. PCT/EP02/12766, filed on Nov. 14, 2002, under 35 U.S.C. §371, which claims priority of European patent application No. 01830703.3, filed on Nov. 14, 2001.

The present invention concerns a system to check and certify the authenticity of labels, and a multiple-access data base used in said system; the term “label” is here meant to include any identification mark applied on or associated to an autonomous support, or directly to an article or to an object, for the purpose of identifying its origin. Where present, the label support can consist of the most different materials, such as paper, cardboard, fabrics, plastic, leather, metals, and it can take up the most different shapes commonly adopted on the market.

In the last ten years, the problem of counterfeiting products marked by trade mark labels has totally changed in its aspects and dimensions. From a marginal phenomenon spread among singles or small organizations, it has in fact gradually turned into a hidden activity, very well organized and competitive, as well as being spread throughout the world, mostly under the control of criminal organizations which make a considerable profit therefrom. It is appropriate to point out at once that, by the term “counterfeitness”, one means to simply refer hereinafter to the introduction on the market of products, basically identical to the original products with which the counterfeiter hence tries to mix up his own goods, without considering instead those products which, though imitating trade marks or patents of third parties, do not seek the identity or liability of confusion with the original product, from which they thus differ in a sufficiently perceptible way, at least for an acute observer.

The exponential growth of this phenomenon (an estimated 1300% growth in the last decade of the century) has kept up with the increase in the difference between the actual production cost (constant or decreasing, thanks to the rationalization and delocalization of the production) and the sale price of the product which, for high-quality or anyhow widely advertised products, can be kept at much higher levels. This wide gap between production cost and sale price hence gives a great possibility to the well structured and technically advanced organizations to act on the market and be able not only to counterfeit the products without any apparent change in the quality thereof, but also to most efficiently forge labels, trade marks, identification marks and whatever has so far been conceived to try and oppose this phenomenon.

On the other hand, the actual delocalization of the production has contributed to develop the phenomenon of counterfeiting, considering that the production centres are often very far from the parent company and can thus less easily be controlled by the same; it therefore often happens that the same authorized producer increases his own production beyond that established by the parent company, introducing on the market—often through the same distribution line of the original products—a counterfeited production which, in this case, is obviously fully identical to the original one.

Another characteristic of the counterfeiting of products, now-a-days present on the market, is that there is no longer any sectorial restriction, that is, it indifferently involves any type of industrial product allowing a sufficiently high margin between sale price and production cost such as to make its imitation appetizing. The phenomenon of counterfeitness is hence widely spread not only in the most “traditional” sectors of clothing articles and jewellery, but also in the sectors of watches, eyeglasses, photographic material, audio-visual equipment, compact disks and tapes, software, sports articles, food products, perfumes, cigarettes, and even in the chemical, agrochemical, cosmetic and pharmaceutical sectors, thereby causing serious economical damages both to the producers and to the final consumers. These last ones are in fact not only highly exposed to the risk of frauds—considering the substantial impossibility for them to distinguish directly an original product from a counterfeited product—but they can also be damaged as far as health is concerned when a counterfeited product, which can obviously give no quality guarantee, is a food product, a pharmaceutical product or a product designed to come in contact with the skin. It is deemed at present that the turnover of counterfeited products corresponds to about 5-6% of the worldwide trade. The phenomenon has thus reached really worrying dimensions.

Against this very fast widespreading of the counterfeiting of any type of products, the steps adopted so far to check this phenomenon have not evidenced a corresponding standard of quality. In fact, although new types of anti-counterfeiting devices have been proposed and are still being proposed, none of them has so far succeeded in efficiently and decisively opposing the constant expansion of the phenomenon of counterfeitness.

A first very widespread category of anti-counterfeiting devices is in fact based on the concept of reckoning a lot or a series of products, or the respective label, by examining one or more identification marks applied thereon in an identical manner for the whole lot or series of products. The identification marks can also not be directly visible with the naked eye, in which case they are detected through simple apparatuses; the originality of the product or of the label is reckoned when the identification marks detected show the same characteristics of the original ones. However, this type of anti-counterfeiting devices proves to be effective, now-a-days, only against the unrefined counterfeiters of the first generation, but it does not prove to be substantially successful against the organized counterfeiters—of the so-called second generation—who dispose of highly sophisticated technical means and who are able to perfectly reproduce any new type of identification mark applied on products or labels, already a few months after they have appeared on the market.

A second, far more limited, group of anti-counterfeiting devices is instead based on the detection of microscopic features intrinsic of each single product or to a label thereof, which features have to be detected within a narrow and well defined portion of the product and are memorized for subsequent comparison. In this case, checking the authenticity of the product requires the help of an expert and the use of rather complex, costly and bulky machinery, so that these anti-counterfeiting devices have up-to-date been limited to the identification of particularly valuable articles (as works of art, archeological and historical finds, banknotes and the like) and said identification can be exclusively carried out by experts of the sector; consequently, up-to-date, there has been no concrete possibility to use this type of anti-counterfeiting devices to defend articles of wide consumption.

An important improvement in this second type of anti-counterfeiting devices has been introduced by the Applicant with the PCT Patent Application N. IB00/01544. This application discloses in fact an anti-counterfeiting method based on detecting, for each single label, a specific distinctive feature, said feature being supplied by the combination between the basic structure of the label support—appropriately evidenced through a suitable lighting—and a particular marking impressed thereon. Thus, in order to accurately detect said distinctive feature, it is not necessary to go as far as analyzing the label on a microscopic level, but it is sufficient to take a photomacrography thereof, which will evidence the combination design—unique and distinctive—formed between the special marking impressed on the label support and the structure of the actual support.

Hence, a label thus conceived has allowed to solve the counterfeiting problem at least from a conceptual point of view, it being possible to distinguish the original products from the counterfeited products no longer on the basis of one or more identification marks—fully identical for a whole lot or series of products and, for this very reason, easily liable to be reproduced by the counterfeiter—but on the basis of a combination design—unique for each single label and not liable to be reproduced, seen that its origin depends on the casual mutual arrangement between the support and the device impressing the marking thereon—apt to be detected through a simple photomacrographic technique.

Of course to find a solution to the counterfeiting problem, not only for what concerns the theoretical certainty to be able to distinguish—with no possibility of error—a forged label from an original one, but also for what concerns the practical applicability of said solution by the whole production line—i.e., production, distribution and sale of the products up to the final consumer—it has been necessary for the Applicant to carry out new studies and experiments in order to create the most efficient means allowing to reach this object.

It should in fact not be forgotten that an efficient check of the counterfeiting—taking into account the conditions of delocalized and frequently changing distribution now existing in all the industrialized countries—requires to carry out fast and realiable checks on the originality of the products not only on the site of the final retailers but also, and perhaps above all, on the site of the delocalized producers, the distributors, the transport companies and, in general, of all the persons concerned with the logistics.

The object of the present invention is to thus supply a system to check and certify the authenticity of labels—of the type described above, comprising a distinctive feature differing for each label—allowing to make the most of this positive feature, so as to enable any element of the production, distribution and sales line to quickly and positively reckon the authenticity of the labels found on the market and, in particular, to allow the final consumer to be certain of the authenticity of the purchased product.

According to the present invention, said object is reached by means of a system to check and certify the authenticity of labels which comprises the innovative characte-ristics defined in the accompanying claims.

The invention will now be described in further detail, also with reference to the accompanying drawings which illustrate a preferred embodiment thereof and in which:

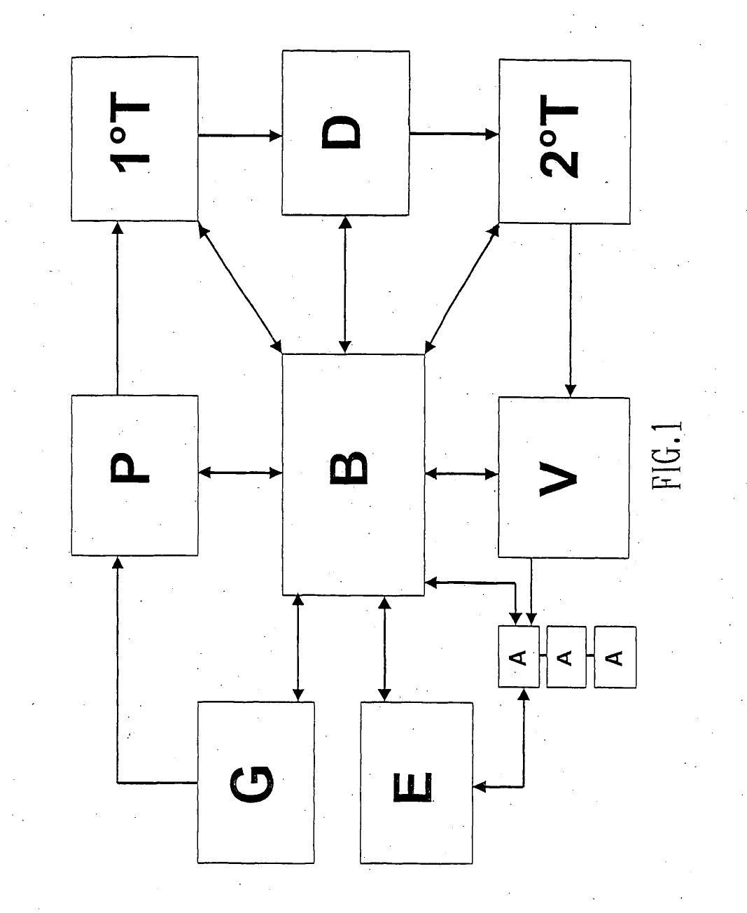

FIG. 1 is a block diagram, illustrating the working of the system to check and certify the authenticity of labels, according to the present invention; and

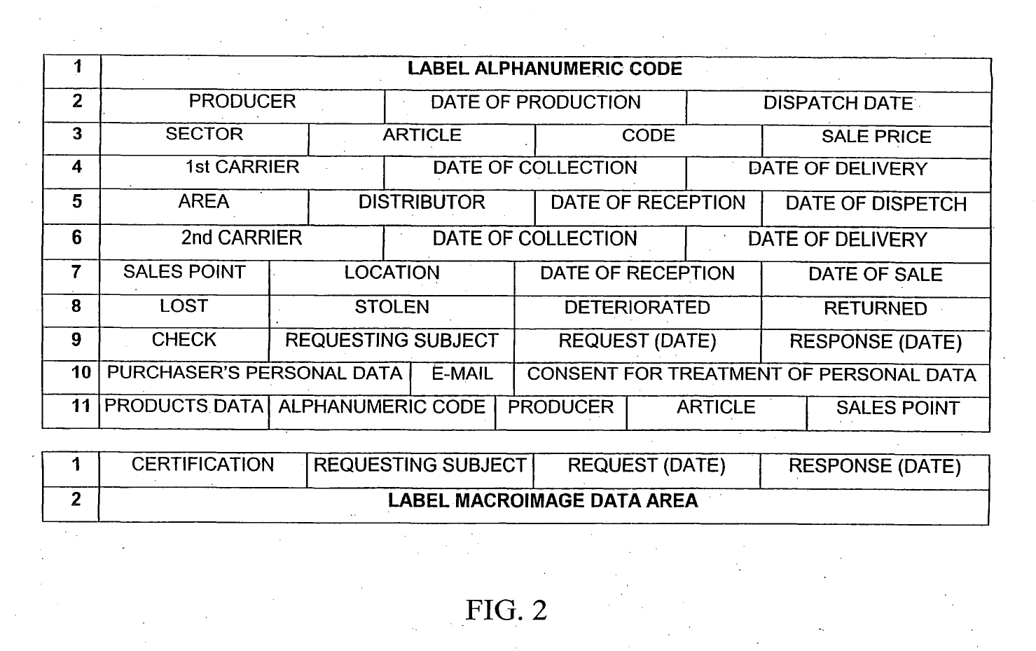

FIG. 2 is a schedule reporting the structure of the information stored in the data base used in the system illustrated in FIG. 1.

The system to check and certify the authenticity of labels according to the present invention has totally abandoned the concept adopted so far for the anti-counterfeiting systems known up-to-date on the market, whose structure—save for any minor changes according to the type of article involved—substantially involves the following steps:
a) production of labels provided with one or more identification signs, identical for all the labels of a same lot or series of products;
b) application of the labels on the products (which can also not be carried out if the identification marks are incorporated into the product while it is being produced, as it happens for example in the case of banknotes);
c) distribution of the products;
d) sample checking—carried out by inspectors specifically appointed for the purpose (or, at times, also by retail dealers of the product)—on the authenticity of the labels found on the products on sale or in circulation.

The aforedescribed known-type systems to check the authenticity of labels have proved to be totally insufficient to stop the counterfeiting phenomenon, for the following fundamental reasons. A first significant problem derives from the fact that the identification signs applied on the labels are fully identical for a whole lot or series of labels; it is thus impossible, even in theory, to distinguish an authentic label from an identically forged label; that is, when the identification signs are faultlessly reproduced on the forged label, this can by no means be distinguished from an original label. Seen the increasingly refined technical abilities of the organizations dealing with counterfeits, this hence represents a significant point of weakness of the known-type anti-counterfeiting systems.

Secondly, in the aforedescribed known-type systems, the authenticity of the labels can be checked merely at the end of the production, distribution and sales line, thus leaving a wide gap for fraudulent actions—for example, of theft or replacement of the original labels—in the various passages through which the labels and products have to go in said line, or else during transport thereof.

In the third place, the operations to check the counterfeiting of labels are concentrated on a single subject, namely the inspection service of the producer, no checking being performed by the other subjects of the line (who are often not allowed to do it, in the attempt to keep a higher level of secrecy on the type of anti-counterfeiting devices adopted) and, in particular, making it impossible for the final user—who is instead the subject mostly interested in making sure that the purchased product is really original—to carry out said check, since he does not possess the technical knowledge and the instruments required for said checks, and can thus exclusively rely on the retail dealer. It is hence quite evident that the known-type anti-counterfeiting systems are designed to control the counterfeiting phenomenon in fully general terms, that is, that they are positively not meant to provide a specific protection to the final consumer as to the originality of the purchased products.

Whereas, the system according to the present invention faces the problem of checking the counterfeiting of products starting from a logical approach which is totally different from that commonly adopted, and it is for this very reason that it succeeds in thoroughly eliminating the drawbacks mentioned heretofore. In particular, according to said approach, the following steps are substantially taken:
A) use of labels having a distinctive feature, unique and unreproduceable for each single label;
B) application of the labels on the products by any known system;
C) distribution of the products;
D) sample checks on the authenticity of the labels applied on the products on sale or in circulation, carried out by any subject of the production, distribution and sales line;
E) check on the authenticity of the label applied on the purchased product, carried out directly by the final consumer.

Such an exceptional result—apt to radically change the concept of checking and monitoring the counterfeiting of products, such as adopted up-to-date—has been made possible by the combination of two technical elements involving highly innovating features: on one hand, the already cited method to check the authenticity of a label, according to the PCT Patent Application N. IB00/01544 and, on the other hand, a multiple-access data base in which a set of data relative to each single label, including the data concerning the macroimage, is stored in a central memory so as to be made available in peripheral units—according to the different access modes which will result more clear hereinafter, and through a data transmission network—to all the subjects of the production, distribution and sales line, to the final purchasers and to an external certification agency. For a general use, seen the capillarity of its present distribution, the preferred data transmission network is Internet; for more sectorial uses, any other type of network can be used, apt to interconnect the interested subjects.

It is appropriate to underline that, although the present invention has been conceived as a natural development of the method to check the authenticity of labels described in the PCT IB00/01544, it is not limited to the use of such a method. From the present description it will in fact result quite evident that, any method allowing to detect a distinctive feature in a label, unique and unreproduceable for each label, and to obtain therefrom a set of memorizable and comparable data, is equally suited for the purpose. Thus, for the sake of convenience, reference will always be made hereinafter to a “photomacrography” of a label, it being however understood that this term should be extensively interpreted as a “set of memorizable and comparable data drawn from a label”.

The general structure of the system to check and certify the authenticity of labels, according to the present invention, is illustrated on the block diagram of FIG. 1. The central block B represents the data base into which is stored all the data used by the system to check and certify the authenticity of each single label. While a detailed description will be given hereunder on the contents of this data base, it is now important to note that it represents a multiuser data base, to which may gain access—with different regulated modes, for example through respective passwords—all the subjects of the production, distribution and sales line of the product, namely in general and for each single product: a producer P, a first carrier 1°T, a distributor D, a second carrier 2°T, a sales point V and, finally, a purchaser A. To the data base may also gain access the handler G of the data base, and an independent certifying agency E. The diagram reported in FIG. 1 is of course a mere example and can thus vary, also to a considerable extent, according to the different types of products and to the logistics adopted for the distribution of such products.

As a general rule, any of these subjects may gain access to the data base B in a bidirectional way, that is, he has the possibility to read the information existing on the data base and to insert other information therein. The different access modes are controlled by the handler G through the grant and regulation of passwords at different levels, so as to structure the system according to the conditions of marketing and distribution of each specific product.

By mere way of example, and taking into account that the production, distribu-tion and sales line may obviously involve—according to each single situation—an increased or reduced number of passages in respect of that illustrated heretofore, the different subjects will have the following possibilities of access and interaction with the data base B.

The handler G, after having reckoned the requirements of the producer P, super-intends the production of a lot of labels, using textile, paper, plastic or metal supports, onto which are impressed the identification signs which form the marking. The material of the support is chosen both in relation to the type of product having to be labelled and in view to obtain a suitable image—through a photomacrographic shot—of the support structure in combination with the marking impressed thereon. Onto each label there are impressed—in addition to the trade mark and to the data normally requested by the producer (article code; bar code, microchip or other devices for the logistics and the traceability of the product)—an alphanumeric code, for the identification of each single label, predefined by the handler G.

A photomacrographic image is shot of each single label thus prepared, said image being apt to place in evidence at least one portion of the marking, as well as the structure of the label support in correspondence of said marking. As already said, by the term marking is meant any identification sign which has been applied onto the support forming the label, as for example the trade mark or other indications or marks applied on the label. A practical and convenient choice is to use as a marking the same alphanumeric code which identifies the label.

In this case, said code performs a double function. On one hand, with its alphanumeric significance, it forms a logic type identification code for the label and, preferably, it forms the record/access key of the label data in the data base B. On the other hand, the same code, with its exclusively graphic meaning and superposed on the structure of the label support—which structure, as better explained in the aforecited patent, is evidenced with appropriate lighting techniques—forms the unreproduceable distinctive feature of each single label. In fact, owing to the casual positioning of the alphanumeric code on the support, during the printing process it is never possible to produce a label having the same combination design between the pattern formed by the alphanumeric code and the pattern formed by the structure of the support, which combination is actually detected through the aforecited photomacrographic technique.

A substantially similar process is also carried out when the label has no support, namely when the identification signs are impressed directly on the product; in this case, of course, it will be necessary to arrange for a cooperation between the producer P and the handler G, in order to detect the data of the label and of its macrographic image at the moment in which it is formed on the product, or even subsequently.

A typical example is illustrated in the schedule of FIG. 2, reporting the structure of the information stored in the data base B. The insertion in said data base of the data concerning each single label involves an initial step wherein the data of the photoma-crographic image and some other data pertaining to the handler G is stored in the memory; subsequently, during the various passages of the label from the producer up to the final consumer, further data is memorized time after time by the different subjects of the production, distribution and sales line, as explained more in detail hereinafter.

The handler G hence provides to memorize in the data base B, for each single label being produced, an alphanumeric code which univocally identifies the label; said code is recorded in line 1, while the data of the photomacrographic image, or macroimage, is recorded in the field 13. Other data inserted in this step in the data base B by the handler G concerns the name of the producer (line 2-field 1) and, eventually, the production sector (line 3-field 1). All the fields controlled by the handler G are of course available, only through reading, to all the other subjects who gain access to the data base B, which means that they cannot be modified.

At the end of this recording step in the data base B, the labels can be freely introduced on the market, with the certainty that, in each point of the production, distribution and sales line, each interested subject is enabled both to check directly the authenticity of each single label, and to obtain a certification of said authenticity by the independent certifying agency E, according to an essential characteristic of the system of the present invention, as will be explained in further detail hereinafter, with reference to each single subject.

The labels thus prepared by the handler G, and duly recorded in the data base B, are then sent to the producer P. This latter can first of all carry out a first check on the authenticity of the labels received, by verifying directly in the data base B that, in correspondence of the alphanumeric codes of the labels received, are actually recorded his own name in the field “producer” and the correct data in the other fields filled in by the handler G. The access of the producer P to the data base B is of course limited to the mere codes of the labels already sent to him; furthermore, while the reading is free for all the fields, the possibility to modify the contents thereof is limited to those fields pertaining to the producer P and not already filled in by the handler G. In the example shown in FIG. 2, the producer P will have the possibility, as the labels are used by being applied on the respective products, to fill in: all the fields in lines 2 and 3 concerning the dates of production and dispatch, and any different data concerning the product, such as for example the article code and the sale price; the field 1 in line 4, namely the name of the first carrier 1°T charged to convey the labelled products to the distributor D; the fields 1 and 2 in line 5, namely the area in which the product is sent and the name of the distributor D. Alternatively, the first carrier 1°T can be replaced by a full logistics service, apt to entirely handle the whole post-production phase related to storage and distribution of the products, up to the final sales point V.

As well as checking directly the congruency between the alphanumeric codes of the labels received and the data memorized in the data base B in correspondence of such codes, the producer P—in order to be positively certain of the authenticity of the labels, and thus exclude any possible errors in the production or in the filling-in of the data in the data base B, or even any forgings and replacements of the labels by the staff of the handler G or by the persons charged with the transport and delivery of the labels—should preferably request the independent certifying agency E to certify the authenticity of one or more sample labels selected among the ones received.

To obtain this certification, the producer P must simply send to the agency E a portion of the labels which he wishes to be certified (and which, of course, he will no longer be able to use for identifying the products), and precisely the portion containing the marking used to detect the distinctive feature in the label when it is first recorded in the data base B. In the event that such a marking should not coincide with the alphanumeric code applied on the label, the portion of the label sent to the agency E will preferably have to contain also said code.

After having received the aforecited label portions, the agency E will provide to take a photomacrographic image thereof, in the same conditions adopted by the handler G when creating the original macroimage, and to then compare said image—by suitable techniques of automatic electronic comparison, now well known per sé—to the macroimage which has been recorded, in correspondence of the alphanumeric code applied on the label, in the field 13 of the data base B. Alternatively, and apart from the possibility to provide an alphanumeric code differing for each label, it is even possible to carry out a multiple comparison—also well known to the skilled in the art—between the detected macroimage and all the macroimages recorded in relation, for example, to the same producer or to the same article code. The result of the comparison is then sent to the producer and the respective data is inserted by the agency E in line 12 of the data base B.

The other subjects of the production, distribution and sales line operate in a similar way to what has been described above. In fact, all these subjects have the possibility to gain access merely to the alphanumeric codes of the labels which they have to deal with, and which hence report their name in the appropriate fields. The access to such codes through reading is complete, so that each subject has a wide and immediate possibility to check the intermediate passages of the products, while more limited possibilities are provided to gain access, in writing mode, only to those fields which concern the specific activity of the subject in connection with the products.

In the example on how to handle the data base B, illustrated in FIG. 2, the first carrier 1°T is enabled to insert the dates of collection and delivery in the fields 2 and 3 of line 4, exactly as done by the second carrier 2°T—charged to convey the products from the distributor D to the sales point V—in the fields 2 and 3 of line 6. The distributor D is normally enabled to insert the pertinent data in the fields 3 and 4 of line 5—concerning the handling dates of the products—as well as in the field 1 of line 6 and in the fields 1 and 2 of line 7, which report the name of the second carrier 2°T and of the sales point V, and the location of this latter. Finally, the sales point V can insert the dates of reception and of sale of the products in the fields 3 and 4 of line 7. In line 8 can eventually be reported any possible alterations in the state of the product—for example, when the product gets lost, or stolen, is deteriorated or returned to the producer—and this line can be filled in by the distributor D, by the sales point V, or by the actual producer P, according to the moment in which the alteration has occurred and to the handling modes of the distribution line.

According to one of the most innovating characteristics of the checking and certifying system of the present invention, also the final purchasers A are in turn enabled—just like the other subjects cited heretofore—both to gain direct access to the data base B, so as to check the authenticity of the product, and to send a portion of the label to the independent certifying agency E, so as to obtain a certification of authenticity according to the modes already described heretofore.

The purchaser can carry out a direct checking, by gaining direct access to the data base B, on the basis of a series of details acquired on the purchase done. It is possible, for example, to request to the purchaser the data of the purchased product indicated in the fields 2 to 6 of line 11 of FIG. 2, namely: alphanumeric code of the label, name of the producer (namely the trade mark), a description of the article, the purchase location and, finally, the name of the sales point V. The insertion of the requested details can be facilitated by using drop-down menus allowing to evidence to the purchaser the different possible options for each single item. If the data concerning the purchase, supplied by the purchaser, coincides with that memorized in the data base B, a response of congruency is issued; in the contrary event, a response of non-congruency is issued; the purchaser is anyhow invited to request to the independent certifying agency E a certification of the label, so as to establish in an unconfutable way whether the purchased product is original or counterfeited.

The certification is requested to the independent certifying agency E exactly in the same way as specified heretofore in relation to the producer P. That is, the purchaser removes the indicated label portion and sends it to the agency E who, after having provided to check the congruency of the macroimage with that memorized in the data base B, issues a positive, or negative, response of certification. In the event of a negative response, a special notification is sent to the producer, who can thus start off the previously foreseen commercial procedures.

As it appears evident from the above description, the certification of authenticity of a label is done on a portion thereof which has to be removed from the original label; it is hence understood that only one certification can be done for each product, the results of which—as said above—are memorized in line 12 of the data base B. Obviously, when the certification is requested by the producer P (or even by the distributor D or by the sales point V, when they suspect to have received counterfeited products) on a sampling basis, the labels used for the certification can no longer be used to identify a product on sale, which must hence be relabelled.

For what concerns the checking operations, it is instead clear that they can be requested, with no problems, even by more subjects for the same article. When the producer P or the handler G should wish to have a trace of such requests—for statistical purposes or to study the phenomenon—a multiple line 9 is provided in the data base B wherein, for each single checking request, there are recorded the requesting subject (field 1), the date of the request (field 2) and, finally, the issue of the response (field 3), which response is of course always contextual to the request.

Always for statistical or commercial purposes, and also to limit improper or ludic uses of the system, the access of the purchaser to check the authenticity of the label can be subject to the request of his personal data (line 11, field 1), of an e-mail address of the purchaser (line 11, field 2) to transmit the results of the certification and, finally, of a declaration of consent for the treatment of his personal data (line 11, field 3).

From the previous description it should be clear how the system according to the present invention allows to fully reach the intended object, making available to the entire production, distribution and sales line a system to check and certify the authenticity of labels, which is within immediate reach of all the subjects of the line, including the final consumers, without having to use any special instruments, apart from a simple computer allowing to gain access to Internet. The direct access enables said subjects to check the authenticity of the label on the basis of a response of congruency between the original data of the single label and the data relating to its “history” up to the moment of its check, thereby making a possible conterfeiting of the label far more difficult. In fact, said label would not only have to be forged in its original coding, but also throughout the history of its subsequent passages along the production, distribution and sales line.

Furthermore, the system according to the present invention allows all the subjects of the line to gain also an indirect access for the certification of the label, which certification is supplied by an agency E which is independent both from the handler G and from the producer P and which thus forms a special guarantee for the final purchaser. The certification is done on the basis of a direct examination, on the part of the agency E, of a portion of the label, by checking whether the distinctive feature present therein corresponds to that originally memorized in the data base B and thus providing a full level of safety as far as reckoning any counterfeits. For a further guarantee of privacy and in order to reduce any possible risk of manipulations, the data base B can be physically kept by two different subjects, leaving under the control of the handler G the information reported in lines 1 to 11 of the table of FIG. 2, and under the direct control of the independent certifying agency E the information reported in lines 12 and 13 of the same table.

Since the check on the authenticity of the labels is no longer entrusted to a single subject, but is distributed among all the subjects of the line, including the final purchasers, it is evident that the number of checks carried out—also thanks to the easiness thereof—is enormously increased, hence allowing to obtain a far deeper knowledge of the counterfeiting phenomenon and of its insertion channels in the legal circuit, so that the opposing actions can become far more timely and effective.

The system to check and certify the authenticity of labels, according to the present invention, has been described with reference to a particular embodiment thereof and to a special logic structure of the data base used therein. It is evident, however, that the protection scope of the invention is not limited to said embodiment and to such a data base structure, which have been supplied by mere way of example and in which wide variants can be introduced, as well as additions and modifications by the technicians skilled in the art, in order to adapt the system according to the invention to the requirements of each single case. It is hence understood that the scope of the present invention falls exclusively within the contents of the accompanying claims.

1-20. (canceled)

21. System to check and certify the authenticity of labels apt to mark goods and articles or other market objects in general, such labels including a support onto which is applied a marking consisting of one or more identification signs, characterized in that it comprises:
a) an alphanumeric code identifying each label;
b) a set of memorizable and comparable data drawn from said label, which evidences one or more distinctive features of the structure of said support, of the marking and/or of the alphanumeric code of the label, or of a combination thereof;
c) an information schedule concerning the articles or objects marked by said labels;
d) a multiple-access data base into which are memorized, for each label, said alphanumeric code, said set of data and said information schedule;
e) a data transmission network allowing the interested subjects, and an independent certifying agency, to gain access to said data base;
and in that:
the access to said data base allows at least two monitoring levels for a label present on the market, namely:
f) a first monitoring level (check), which requires sending to the data base the alphanumeric code of said label and which allows to check whether, in the data base, the information actually found on the market for the article or object marked by said label corresponds to said code;
g) a second monitoring level (certification), which requires sending to the data base said set of data drawn from the label and which allows to certify the authenticity of the label by comparing the identity between the set of data sent to the data base and the corresponding set of data memorized in the data base.

22. System to check and certify the authenticity of labels, as in claim 21, wherein the marking consists of said alphanumeric code.

23. System to check and certify the authenticity of labels, as in claim 21, wherein the set of memorizable and comparable data drawn from the label consists of a photomacrography of said label, in correspondence of said marking.

24. System to check and certify the authenticity of labels, as in claim 21, wherein the information schedule contains data concerning the production and/or sale of said article or object.

25. System to check and certify the authenticity of labels, as in claim 21, wherein said set of memorizable and comparable data drawn from the label is further memorized into a second data base kept by said independent certifying agency.

26. System to check and certify the authenticity of labels, as in claim 21, wherein said data transmission network is Internet.

27. System to check and certify the authenticity of labels, as in claim 21, wherein said interested subjects are all the subjects of the production, distribution and sales line of said articles or objects, as well as the final purchasers.

28. System to check and certify the authenticity of labels, as in claim 21, wherein the comparison of identity operated in said second monitoring level is obtained through a single comparison between the set of data sent to the data base and the set of data memorized in the data base in correspondence of the alphanumeric code identifying the label.

29. System to check and certify the authenticity of labels, as in claim 21, wherein the comparison of identity operated in said second monitoring level is obtained through a multiple comparison between the set of data sent to the data base and the entire group formed by all the sets of data memorized in the data base, or an adequate subgroup thereof.

30. Multiple-access data base, in a system to check and certify the authenticity of labels to mark goods and articles or other market objects in general, such labels including a support onto which is applied a marking consisting of one or more identification signs, characterized in that, said data base is created and updated by detecting and memorizing, for each label produced and introduced on the market:
a) an alphanumeric code identifying each label;
b) a set of memorizable and comparable data drawn from said label, which evidences one or more distinctive features of the structure of said support, of the marking and/or of the alphanumeric code of the label, or of a combination thereof;
c) an information schedule concerning the articles or objects marked by said labels;
and in that,
the access to said data base is obtained through a data transmission network, allowing the interested subjects and an independent certifying agency to gain access to said data base according to at least two monitoring levels for a label present on the market, namely:
d) a first monitoring level (check), which requires sending to the data base the alphanumeric code of said label and which allows to check whether, in the data base, the information actually found on the market for the article or object marked by said label corresponds to said code;
e) a second monitoring level (certification), which requires sending to the data base said set of data drawn from the label and which allows to certify the authenticity of the label by comparing the identity between the set of data sent to the data base and the corresponding set of data memorized in the data base.

31. Multiple-access data base, as in claim 30, wherein the marking consists of said alphanumeric code.

32. Multiple-access data base, as in claim 30, wherein the set of memo-rizable and comparable data drawn from the label consists of a photomacrography of said label, in correspondence of said marking.

33. Multiple-access data base, as in claim 30, wherein the information schedule contains data concerning the production and/or sale of said article or object.

34. Multiple-access data base, as in claim 30, wherein said set of memorizable and comparable data drawn from the label is further memorized into a second data base kept by said independent certifying agency.

35. Multiple-access data base, as in claim 30, wherein said data transmission network is Internet.

36. Multiple-access data base, as in claim 30, wherein said interested subjects are all the subjects of the production, distribution and sales line of said articles or objects, as well as the final purchasers.

37. Multiple-access data base, as in claim 30, wherein the comparison of identity operated in said second monitoring level is obtained through a single comparison between the set of data sent to the data base and the set of data memorized in the data base in correspondence of the alphanumeric code identifying the label.

38. Multiple-access data base, as in claim 30, wherein the comparison of identity operated in said second monitoring level is obtained through a multiple comparison between the set of data sent to the data base and the entire group formed by all the sets of data memorized in the data base, or an adequate subgroup thereof.

39. System to check and certify the authenticity of labels, as in claim 22, wherein the set of memorizable and comparable data drawn from the label consists of a photomacrography of said label, in correspondence of said marking.

40. Multiple-access data base, as in claim 31, wherein the set of memo-rizable and comparable data drawn from the label consists of a photomacrography of said label, in correspondence of said marking.
